SEQUENCE LISTING (2 sequences)

SEQ ID NO: 1 - protein, 583 aa, Bacillus sp. TS-23
NTAPINETMMQYFEWDLPNDGTLWTKVKNEAANLSSLGITALWLPPAYKGTSQSDVGYGVYDLYDLGEFNQKGTIRTKYGTKTQYIQAIQAAKAAGMQVYADVVFNHKAGADGTEFVDAVEVDPSNRNQETSGTYQIQAWTKFDFPGRGNTYSSFKWRWYHFDGTDWDESRKLNRIYKFRSTGKAWDWEVDTENGNYDYLMFADLDMDHPEVVTELKNWGTWYVNTTNIDGFRLDAVKHIKYSFFPDWLTYVRNQTGKNLFAVGEFWSYDVNKLHNYITKTNGSMSLFDAPLHNNFYTASKSSGYFDMRYLLNNTLMKDQPSLAVTLVDNHDTQPGQSLQSWVEPWFKPLAYAFILTRQEGYPCVFYGDYYGIPKYNIPGLKSKIDPLLIARRDYAYGTQRDYIDHQDIIGWTREGIDTKPNSGLAALITDGPGGSKWMYVGKKHAGKVFYDLTGNRSDTVTINADGWGEFKVNGGSVSIWVAKTSNVTFTVNNATTTSGQNVYVVANIPELGNWNTANAIKMNPSSYPTWKATIALPQGKAIEFKFIKKDQAGNVIWESTSNRTYTVPFSSTGSYTASWNVP

SEQ ID NO: 2 - protein, 484 aa, Bacillus sp. TS-23
NTAPINETMMQYFEWDLPNDGTLWTKVKNEAANLSSLGITALWLPPAYKGTSQSDVGYGVYDLYDLGEFNQKGTIRTKYGTKTQYIQAIQAAKAAGMQVYADVVFNHKAGADGTEFVDAVEVDPSNRNQETSGTYQIQAWTKFDFPGRGNTYSSFKWRWYHFDGTDWDESRKLNRIYKFRSTGKAWDWEVDTENGNYDYLMFADLDMDHPEVVTELKNWGTWYVNTTNIDGFRLDAVKHIKYSFFPDWLTYVRNQTGKNLFAVGEFWSYDVNKLHNYITKTNGSMSLFDAPLHNNFYTASKSSGYFDMRYLLNNTLMKDQPSLAVTLVDNHDTQPGQSLQSWVEPWFKPLAYAFILTRQEGYPCVFYGDYYGIPKYNIPGLKSKIDPLLIARRDYAYGTQRDYIDHQDIIGWTREGIDTKPNSGLAALITDGPGGSKWMYVGKKHAGKVFYDLTGNRSDTVTINADGWGEFKVNGGSVSIWVAK

(19) United States
(12) Patent Application Publication
(10) Pub. No.: US 2014/0342965 A1
(43) Pub. Date: Nov. 20, 2014

(54) CLEANING COMPOSITION

(71) Applicant: The Procter & Gamble Company, Cincinnati, OH (US)

(72) Inventors: Philip Frank SOUTER, Northumberland (GB); Michelle JACKSON, Gateshead (GB); Jonathan Richard CLARE, Newcastle-upon-Tyne (GB); Euan John MAGENNIS, Newcastle-upon-Tyne (GB)

(73) Assignee: The Procter & Gamble Company, Cincinnati, OH (US)

(21) Appl. No.: 14/277,179

(22) Filed: May 14, 2014

(30) Foreign Application Priority Data
May 14, 2013 (EP) 13167664.5

(51) Int. Cl. C11D 3/50

(52) U.S. Cl. CPC C11D 3/50
USPC 510/106; 510/107; 510/102; 510/101

(57) ABSTRACT

A cleaning composition, specially designed to fight malodour, comprising a specific perfume and an alpha-amylase with at least 90% identity with an alpha-amylase selected from the alpha-amylase of SEQ ID NO:1 and the alpha-amylase of SEQ ID NO:2.

### FIELD OF THE INVENTION

The present invention relates to a specific amylase and a specific perfume composition to improve malodour fighting properties of a cleaning composition.

### BACKGROUND OF THE INVENTION

Cleaning compositions are expected to provide a nice smell or prevent malodour development.

It is particularly important for the user of a cleaning composition that the composition provides a nice smell and/or is effective at reducing malodour. This is a signal to the consumer that the effective cleaning is obtained. The inventors have found that cleaning compositions comprising a specific amylase and a specific perfume were particularly effective in fighting malodour.

### SUMMARY OF THE INVENTION

The present invention concerns a cleaning composition comprising:
an alpha-amylase with at least 90% identity with an alpha-amylase selected from the alpha-amylase of SEQ ID NO:1 and the alpha-amylase of SEQ ID NO:2;
a perfume comprising a mixture of at least 5 perfume raw materials and wherein the perfume comprises at least 20 wt % of perfume raw material selected from: Lavandin Grosso oil; Iso Propyl-2-Methyl Butyrate; Dimethyl cyclohexenyl 3-butenyl ketone; Eucalyptol; Benzyl Acetate; Hexyl Acetate; Methyl Benzoate; 3a,4,5,6,7,7a-hexahydro-4,7-methano-1H-indenyl acetate; Octanal; Cis-3 hexen-1-ol; Nonanal; Ethyl-2-methyl Butyrate; (Z,E)-2,4-dimethyl cyclohex-3-ene-1-carbaldehyde, Tetrahydro-4-methyl-2-(2-methyl propenyl)-2H-pyran; Geraniol; Iso propylbutanal; 2-pentylcyclopentan-1-ol; Dodecenal; d-limonene; Allyl Caproate; Decenal; Tetra Hydro Linalool; (E)-1-trimethyl-1-cyclohex-3 (2,6,6-enyl)but-2-en-1-one; 2,4,6-trimethyl-3-cyclohexene-1-carboxaldehyde; Ionone Beta; Prenyl Acetate; 3-(4-tert-butylphenyl)propanal; 1 Carvone; Allyl Cyclohexyl Propionate; Linalool; Phenyl ethyl alcohol; Lemon Oil; Eugenol; Ethyl Vanillin; Cis-3-Hexenyl Acetate; Diphenyl Oxyde; Ionone Alpha; prop-2-enyl 2-cyclohexyloxyacetate; 2-pentyl-Cyclopentanone; Ethyl-2-methyl Pentanoate; [(4Z)-1-cyclooct-4-enyl]methyl carbonate; Cedryl Acetate; Cinnamic Alcohol; 2-methoxyethylbenzene; Phenyl Ethyl Phenyl Acetate; Citronellol; 2-tert-butyl cyclohexyl acetate; Citral; 3alpha,4,5,6,7,7alpha-hexahydro-4,7-methano-1H-inden-6-yl propanoate; Iso-bornyl iso-butyrate; and mixture thereof.

The cleaning compositions of the invention are particularly effective at reducing malodour.

The invention also concern the use of an alpha-amylase with at least 90% identity with an alpha-amylase selected from the alpha-amylase of SEQ ID NO:1 and the alpha-amylase of SEQ ID NO:2; and of a perfume comprising a mixture of at least 5 perfume raw materials and wherein the perfume comprises at least 20 wt % of perfume raw material selected from: Lavandin Grosso oil; Iso Propyl-2-Methyl Butyrate; Dimethyl cyclohexenyl 3-butenyl ketone; Eucalyptol; Benzyl Acetate; Hexyl Acetate; Methyl Benzoate; 3a,4,5,6,7,7a-hexahydro-4,7-methano-1H-indenyl acetate; Octanal; Cis-3 hexen-1-ol; Nonanal; Ethyl-2-methyl Butyrate; (Z,E)-2,4-dimethyl cyclohex-3-ene-1-carbaldehyde, Tetrahydro-4-methyl-2-(2-methyl propenyl)-2H-pyran; Geraniol; Iso propylbutanal; 2-pentylcyclopentan-1-ol; Dodecenal; d-limonene; Allyl Caproate; Decenal; Tetra Hydro Linalool; (E)-1-trimethyl-1-cyclohex-3 (2,6,6-enyl)but-2-en-1-one; 2,4,6-trimethyl-3-cyclohexene-1-carboxaldehyde; Ionone Beta; Prenyl Acetate; 3-(4-tert-butylphenyl)propanal; 1 Carvone; Allyl Cyclohexyl Propionate; Linalool; Phenyl ethyl alcohol; Lemon Oil; Eugenol; Ethyl Vanillin; Cis-3-Hexenyl Acetate; Diphenyl Oxyde; Ionone Alpha; prop-2-enyl 2-cyclohexyloxyacetate; 2-pentyl-Cyclopentanone; Ethyl-2-methyl Pentanoate; [(4Z)-1-cyclooct-4-enyl]methyl carbonate; Cedryl Acetate; Cinnamic Alcohol; 2-methoxyethylbenzene; Phenyl Ethyl Phenyl Acetate; Citronellol; 2-tert-butyl cyclohexyl acetate; Citral; 3alpha,4,5,6,7,7alpha-hexahydro-4,7-methano-1H-inden-6-yl propanoate; Iso-bornyl iso-butyrate; and mixture thereof; to prepare a cleaning composition to reduce malodour.

Unless specified otherwise, percentages and ratio are expressed in weight.

### DETAILED DESCRIPTION OF THE INVENTION

The cleaning compositions may comprise light duty or heavy duty liquid detergent compositions, hard surface cleaning compositions, fabric enhancers, detergent gels commonly used for laundry, bleach and laundry additives, shampoos, body washes, and other personal care compositions.

Cleaning compositions may take the form of a liquid, solid or a powder. Liquid compositions may comprise a solid. The cleaning composition may be encompassed in a pouch. Solids may include powder or agglomerates, such as micro-capsules, beads, noodles or one or more pearlized balls or mixtures thereof. Such a solid element may provide a technical benefit, through the wash or as a pre-treat, delayed or sequential release component; additionally or alternatively, it may provide an aesthetic effect.

The Alpha-Amylase

The cleaning composition of this invention comprises an alpha-amylase with at least 90%, preferably at least 95%, or at least 98%, or 99% or 100% identity with an alpha-amylase selected from the alpha-amylase of SEQ ID NO:1; and the alpha-amylase of SEQ ID NO:2.

The cleaning composition may comprise at least 0.01% or at least 0.02%, or from 0.05% to 10%, or from 0.1% to 5% or from 0.2% to 2% of an alpha-amylase.

The alpha-amylase may have 100% identity with the alpha-amylase of SEQ ID NO:1; or SEQ ID NO:2. The alpha-amylase may distinguish from the alpha-amylase of SEQ ID NO:1; or SEQ ID NO:2 by at least 1 mutation, or by at least 2, or 3, or 5, or 10, or 15, or 20 mutations. The 1 or more mutation may occur at one or more of the following positions: 2, 7, 22, 25, 28, 29, 30, 35, 37, 53, 60, 70, 72, 75, 83, 87, 91, 93, 108, 116, 125, 126, 128, 129, 130, 131, 134, 136, 138, 142, 156, 160, 161, 165, 178, 182, 183, 185, 189, 192, 195, 197, 202, 210, 214, 217, 221, 234, 246, 269, 270, 279, 283, 298, 303, 305, 306, 310, 319, 320, 337, 340, 374, 375, 376, 379, 401, 407, 419, 433, 438, 453, 475, 476, and 483.

The alpha-amylase may distinguish from the alpha-amylase of SEQ ID NO:1 or SEQ ID NO:2 by at least 1 mutation, or by at least 2, or 3, or 5, or 10, or 15, or 20, or 30, or 40 mutations at one or more of the following positions: 7, 29, 35, 53, 60, 72, 87, 108, 116, 126, 128, 129, 130, 131, 134, 136, 138, 142, 156, 161, 165, 178, 182, 185, 189, 192, 195, 197, 202, 210, 214, 217, 221, 234, 246, 269, 303, 310, 337, 340, 374, 401, and 438.

The alpha-amylase may distinguish from the alpha-amylase of SEQ ID NO:1 or SEQ ID NO:2 by at least 1 mutation, or by at least 2, or 3, or 5, or 10, or 15, or 20, or 30, mutations at one or more of the following positions: 2, 7, 22, 25, 28, 30, 37, 70, 75, 83, 87, 91, 93, 108, 128, 160, 165, 178, 182, 183, 217, 269, 270, 279, 283, 298, 305, 306, 310, 320, 374, 375, 376, 407, 419, 475, and 476.

The alpha-amylase may distinguish from the alpha-amylase of SEQ ID NO:1 or SEQ ID NO:2 by at least 1 mutation, or by at least 2, or 3, or 5, or 10, or 15, or 20 mutations at one or more of the following positions: 83, 125, 128, 131, 160, 178, 182, 183, 185, 189, 279, 305, 319, 320, 379, 407, 433, 453, 475, 476, and 483.

The alpha-amylase may distinguish from the alpha-amylase of SEQ ID NO:1 or SEQ ID NO:2 by at least 1 mutation, or by at least 2, or 3, or 5 mutations selected from S125A, N128C, T131I, T165I, K178L, T182G, F202Y, S243Q, Y305R, D319T and G475K.

The alpha-amylase may distinguish from the alpha-amylase of SEQ ID NO:1 or SEQ ID NO:2 by at least a S243Q mutation.

The alpha-amylase may distinguish from the alpha-amylase of SEQ ID NO:1 or SEQ ID to NO:2 by at least a S243Q and a G475K mutation.

The alpha-amylase may distinguish from the alpha-amylase of SEQ ID NO:1 or SEQ ID NO:2 by at least a N128C, a K178L, a T182G, a Y305R, and a G475K mutation.

The alpha-amylase may distinguish from the alpha-amylase of SEQ ID NO:1 or SEQ ID NO:2 by at least a N128C, a K178L, a T182G, a F202Y, a S243Q, a Y305R, a D319T, and a G475K mutation.

The alpha-amylase may distinguish from the alpha-amylase of SEQ ID NO:1 or SEQ ID NO:2 by at least a S125A, a N128C, a K178L, a T182G, a S243Q, a Y305R, and a G475K; mutation.

The alpha-amylase may distinguish from the alpha-amylase of SEQ ID NO:1 or SEQ ID NO:2 by at least a S125A, a N128C, a T131I, a T165I, a K178L, a T182G, a S243Q, a Y305R and a G475K mutation.

Suitable amylases according to the invention can be found in WO2010/115028 and WO2010/115021.

In addition to the alpha-amylase with at least 90%, identity with an alpha-amylase selected from the alpha-amylase of SEQ ID NO:1; and the alpha-amylase of SEQ ID NO:2, the cleaning composition may further comprise an additional amylase. The additional amylase may comprises an amylase with greater than 60% identity to the AA560 alpha amylase endogenous to Bacillus sp. DSM 12649, preferably a variant of the AA560 alpha amylase endogenous to Bacillus sp. DSM 12649 having:

(a) mutations at one or more of positions 9, 26, 149. 182, 186, 202, 257, 295, 299, 323, 339 and 345; and
(b) optionally with one or more, preferably all of the substitutions and/or deletions in the following positions: 118, 183, 184, 195, 320 and 458, which if present preferably comprise R118K, D183*, G184*, N195F, R320K and/or R458K.

Suitable commercially available additional amylase enzymes include Stainzyme® Plus, Stainzyme®, Natalase®, Termamyl®, Termamyl® Ultra, Liquezyme® SZ (all Novozymes, Bagsvaerd, Denmark) and Spezyme® AA or Ultraphlow (DuPont®, Palo Alto, USA). The additional amylase may be in the form of granulates or liquids or mixtures thereof.

The Perfume

The cleaning composition may comprise from 0.01% to 10%, or from 0.1% to 5%, or even from 0.2% to 2% by weight of a perfume composition. The composition may comprise at least 0.75% or at least 1% by weight of a perfume composition.

The perfume comprises a mixture of at least 5, preferably at least 7, or at least 10, or at least 15 perfume raw materials.

The perfume comprises at least 20% per weight, in particular at least 40%, or at least 50%, or at least 70%, or at least 90%, for example from 60% to 100%, or from 80% to 99.9% per weight of perfume raw material selected from: Lavandin Grosso oil; Iso Propyl-2-Methyl Butyrate; Dimethyl cyclohexenyl 3-butenyl ketone; Eucalyptol; Benzyl Acetate; Hexyl Acetate; Methyl Benzoate; 3a,4,5,6,7,7a-hexahydro-4,7-methano-1H-indenyl acetate; Octanal; Cis-3 hexen-1-ol; Nonanal; Ethyl-2-methyl Butyrate; (Z,E)-2,4-dimethyl cyclohex-3-ene-1-carbaldehyde, Tetrahydro-4-methyl-2-(2-methyl propenyl)-2H-pyran; Geraniol; Iso propylbutanal; 2-pentylcyclopentan-1-ol; Dodecenal; d-limonene; Allyl Caproate; Decenal; Tetra Hydro Linalool; (E)-1-trimethyl-1-cyclohex-3(2,6,6-enyl)but-2-en-1-one; 2,4,6-trimethyl-3-cyclohexene-1-carboxaldehyde; Ionone Beta; Prenyl Acetate; 3-(4-tert-butylphenyl)propanal; 1 Carvone; Allyl Cyclohexyl Propionate; Linalool; Phenyl ethyl alcohol; Lemon Oil; Eugenol; Ethyl Vanillin; Cis-3-Hexenyl Acetate; Diphenyl Oxyde; Ionone Alpha; prop-2-enyl 2-cyclohexyloxyacetate; 2-pentyl-Cyclopentanone; Ethyl-2-methyl Pentanoate; [(4Z)-1-cyclooct-4-enyl]methyl carbonate; Cedryl Acetate; Cinnamic Alcohol; 2-methoxyethylbenzene; Phenyl Ethyl Phenyl Acetate; Citronellol; 2-tert-butyl cyclohexyl acetate; Citral; 3alpha,4,5,6,7,7alpha-hexahydro-4,7-methano-1H-inden-6-yl propanoate; Iso-bornyl iso-butyrate; and mixture thereof.

Preferably, the perfume composition comprises at least 20% per weight, in particular at least 40%, or at least 50%, or at least 70%, or at least 90%, for example from 60% to 100% per weight of perfume raw material selected from Lavandin Grosso oil; Iso Propyl-2-Methyl Butyrate; Dimethyl cyclohexenyl 3-butenyl ketone; Eucalyptol; Benzyl Acetate; Hexyl Acetate; Methyl Benzoate; 3a,4,5,6,7,7a-hexahydro-4,7-methano-1H-indenyl acetate; Octanal; Cis-3 hexen-1-ol; Nonanal; Ethyl-2-methyl Butyrate; (Z,E)-2,4-dimethyl cyclohex-3-ene-1-carbaldehyde, Tetrahydro-4-methyl-2-(2-methyl propenyl)-2H-pyran; Geraniol; Iso propylbutanal; 2-pentylcyclopentan-1-ol; Dodecenal; d-limonene; Allyl Caproate; Decenal; Tetra Hydro Linalool; (E)-1-trimethyl-1-cyclohex-3(2,6,6-enyl)but-2-en-1-one; 2,4,6-trimethyl-3-cyclohexene-1-carboxaldehyde; Ionone Beta; Prenyl Acetate; 3-(4-tert-butylphenyl)propanal; 1 Carvone; Allyl Cyclohexyl Propionate; Linalool; Phenyl ethyl alcohol; Lemon Oil; Eugenol; Ethyl Vanillin; Cis-3-Hexenyl Acetate; Diphenyl Oxyde; Ionone Alpha; and mixture thereof.

Dimethyl cyclohexenyl 3-butenyl ketone is available under the name Neobutenone Alpha®, Galbascone®, Dynascone® or galbanum Ketone®. 3a,4,5,6,7,7a-hexahydro-4,7-methano-1H-indenyl acetate is also known as Flor Acetate or Cyclacet®. Octanal is also known as Octyl Aldehyde. Cis-3 hexen-1-ol is also known as Beta Gamma Hexenol. Nonanal is also known as Nonyl Aldehyde. (Z,E)-2,4-dimethyl cyclohex-3-ene-1-carbaldehyde is also known as Ligustral® or Triplal® or Cyclal®. Tetrahydro-4-methyl-2-(2-methyl propenyl)-2H-pyran is also known as Rose Oxide. Iso propylbutanal is also known as Florhydral®. 2-pentylcyclopentan-1-ol is also known as Cyclopentol®. Dodecenal is also known as Lauric Aldehyde. D-limonene is also known as Orange Terpenes. Allyl Caproate is also known as allyl hexanoate. Decenal is also known as Decyl Aldehyde. (E)-1-trimethyl-1-cyclohex-3(2,6,6-enyl)but-2-en-1-one is also known as Delta Damascone. 2,4,6-trimethyl-3-cyclohexene-1-carboxaldehyde is also known as Cyclo Citral. 3-(4-tert-butylphenyl)propanal is also known as Bourgeonal®. Prop-2-enyl 2-cyclohexyloxyacetate is also known as Cyclo Galbanate®. 2-pentyl-Cyclopentanone is also known as Delphone®. Ethyl-2-methyl Pentanoate is also known as Manzanate®. [(4Z)-1-cyclooct-4-enyl]methyl carbonate is also known as Violiff®. 2-methoxyethylbenzene is also known as Keone or Pandanol. 2-tert-butyl cyclohexyl acetate is also known as Verdox. 3alpha,4,5,6,7,7alpha-hexahydro-4,7-methano-1H-inden-6-yl propanoate is also known as Cyclaprop or Frutene. Iso-bornyl iso-butyrate is also known as Abierate®.

The perfume may be comprised in one or more perfume delivery systems. The perfume delivery system may comprise neat perfume, perfume microcapsules, pro-perfumes, polymer particles, functionalized silicones, polymer assisted delivery, molecule assisted delivery, fiber assisted delivery, amine assisted delivery, cyclodextrins, starch encapsulated accord, zeolite and inorganic carrier, and mixtures thereof. One or more of the perfume delivery system may comprise the preferred raw perfume material described in the 3 above paragraphs. Perfume delivery technologies, methods of making certain perfume delivery technologies and the uses of such perfume delivery technologies are disclosed in US 2007/0275866 A1, US 2004/0110648 A1, US 2004/0092414 A1, 2004/0091445 A1, 2004/0087476 A1, U.S. Pat. Nos. 6,531,444, 6,024,943, 6,042,792, 6,051,540, 4,540,721, and 4,973,422.

The composition may comprise from 0.01% to 10%, or from 0.1% to 5%, or even from 0.2% to 2% by weight of neat perfume. The composition may comprise from 0.01% to 10%, or from 0.1% to 5%, or even from 0.2% to 2% by weight of starch encapsulated accord.

The composition may comprise a perfume microcapsule. The perfume microcapsules may provide longer freshness to the fabric. The composition may comprise from 0.01% to 10%, or from 0.1% to 5%, or even from 0.2% to 2% by weight of a perfume microcapsule.

The perfume microcapsule may comprise an aminoplast material, polyamide material and/or an acrylate material, for example a melamine-formaldehyde or ureaformaldehyde material. The perfume microcapsule may comprise a cationic, nonionic and/or anionic deposition aid. The perfume microcapsule may comprise a deposition aid selected from the group consisting of, a cationic polymer, a nonionic polymer, an anionic polymer and mixtures thereof. The perfume microcapsule may comprise a cationic polymer. The perfume microcapsule may comprise a moisture-activated microcapsule (e.g., cyclodextrin comprising perfume microcapsule).

The Pouch

The cleaning composition of the invention may be encompassed in a pouch.

The invention also concerns a pouch comprising a water-soluble film and the cleaning composition of the invention, the cleaning composition being at least partially encompassed within the water-soluble film. The water-soluble film may comprise at least 50% by weight of a water-soluble polyvinyl alcohol (PVOH) resin, the resin having an average viscosity in a range of 10 cP to 30 cP and a degree of hydrolysis in a range of 84% to 98%.

The pouch comprises at least one sealed compartment. The sealed compartment comprises the cleaning composition. The pouch may comprise a single compartment or multiple compartments. In embodiments comprising multiple compartments, each compartment may contain identical and/or different compositions. In turn, the compositions may take any suitable form including, but not limited to liquid, solid and combinations thereof (e.g. a solid suspended in a liquid). In some embodiments, the pouch comprises a first, second and third compartment, each of which respectively contains a different first, second and third composition. In some embodiments, the compositions may be visually distinct as described in European Patent Application Number 09161692.0 (filed Jun. 2, 2009 and assigned to the Procter & Gamble Company).

The water-soluble film may contain a total of at least 55 wt. %, 60 wt. %, 65 wt. %, 70 wt. %, 75 wt. %, 80 wt. %, 85 wt. %, 90 wt. % of PVOH polyvinylalcohol resin.

The viscosity of a PVOH polymer ( ) is determined by measuring a freshly made solution using a Brookfield LV type viscometer with UL adapter as described in British Standard EN ISO 15023-2:2006 Annex E Brookfield Test method. It is international practice to state the viscosity of 4% aqueous polyvinyl alcohol solutions at 20° C. All viscosities specified herein in Centipoise (cP) should be understood to refer to the viscosity of 4% aqueous polyvinyl alcohol solution at 20° C., unless specified otherwise. Similarly, when a resin is described as having (or not having) a particular viscosity, unless specified otherwise, it is intended that the specified viscosity is the average viscosity for the resin, which inherently has a corresponding molecular weight distribution.

The water-soluble film may comprise at least 50% by weight of polyvinylalcohol resin having an average viscosity of at least 11 cP or 12 cP preferably of at least 13 cP or 14 cP, 15 cP, 16 cP, or 17 cP. The water soluble film may comprise at least 50% by weight of polyvinylalcohol resin having an average viscosity of at most 27 cP or 25 cP preferably of at most 20 cP, or 19 cP, or 17.5 cP. The water soluble film may comprise at least 50% by weight of polyvinylalcohol resin having an average viscosity in a range of 12 cP to 25 cP or 13.5 to 20 cP. The water-soluble film may comprises from 0% to 30% by weight of a PVOH polymer having an average viscosity less than 11 cP.

The weighted log viscosity average ( μ̅) of the polyvinylalcohol resin of the water-soluble film is calculated as follow. The μ̅ is calculated by the formula μ̅=e^{ΣW}^{ᵢ}^{·ln μ}^{ᵢ} In where is the viscosity for the respective PVOH polymers and Wᵢ is the weight fraction of the respective PVOH polymers.

The water-soluble film may comprise at least 50% by weight of polyvinylalcohol resin having a degree of hydrolysis of at least 85% or 87% or 89%. The water-soluble film may comprise at least 50% by weight of polyvinylalcohol resin having a degree of hydrolysis of at most 96%, 94%, 92%, 91%, or 90%. For example, the water-soluble film comprises at least 50% by weight of polyvinylalcohol resin having a degree of hydrolysis in a range of 84% to 95%, or 85% to 91%. As used herein, the degree of hydrolysis is expressed as a percentage of vinyl acetate units converted to vinyl alcohol units.

The weight average degree of hydrolysis ( H̅^̅{̅o̅}̅) of the polyvinylalcohol resin may be between 80 and 98%, or between 84 and 96%, or 87 and 91%. The H̅^̅{̅o̅}̅ is calculated by the formula H̅^̅{̅o̅}̅=Σ(Wi·Hᵢ) where Wᵢ is the weight fraction of the respective PVOH polymers, and Hᵢ is the respective degrees of hydrolysis.

Suitable water-soluble films include M8630, or M8900 which are PVOH copolymer films available from MONOSOL. LLC, Merrillville, Ind. (USA).

### Adjunct Ingredients

The cleaning composition may further comprise one or more of the following non-limiting list of ingredients: fabric care benefit agent; detersive enzyme such as lipase, protease, peroxidase, another amylolytic enzyme, e.g., another alpha-amylase, glucoamylase, maltogenic amylase, CGTase, cellulase, mannanase (such as MANNAWAY™ from Novozymes, Denmark), pectinase, pectine lyase, cutinase, laccase, and mixtures thereof; deposition aid; rheology modifier; builder; bleach; bleaching agent; bleach precursor; bleach booster; bleach catalyst; perfume and/or perfume microcapsules (see for example U.S. Pat. No. 5,137,646); perfume loaded zeolite; starch encapsulated accord; polyglycerol esters; whitening agent; pearlescent agent; enzyme stabilizing systems; scavenging agents including fixing agents for anionic dyes, complexing agents for anionic surfactants, and mixtures thereof; optical brighteners or fluorescers; polymer including but not limited to soil release polymer and/or soil suspension polymer; dispersants; antifoam agents; non-aqueous solvent; fatty acid; suds suppressors, e.g., silicone suds suppressors (see: U.S. Publication No. 2003/0060390 A1, 3/465-77); cationic starches (see: US 2004/0204337 A1 and US 2007/0219111 A1); scum dispersants (see: US 2003/0126282 A1, 3/489-90); dyes; colorants; opacifier; antioxidant; hydrotropes such as toluenesulfonates, cumenesulfonates and naphthalenesulfonates; color speckles; colored beads, spheres or extrudates; clay softening agents. Any one or more of these ingredients is further described in described in European Patent Application Number 09161692.0 (filed Jun. 2, 2009), U.S. Publication Number 2003/0139312A1 (filed May 11, 2000) and U.S. Patent Application No. 61/229,981 (filed Jul. 30, 2009), each of which are assigned to the Procter & Gamble Company. Additionally or alternatively, the compositions may comprise surfactants and/or solvent systems.

Surfactants:

The cleaning compositions may comprise surfactant, in particular from 1% to 80%, or from 5% to 50%, by weight of surfactant.

Surfactants may be of the anionic, nonionic, zwitterionic, ampholytic or cationic type or can comprise compatible mixtures of these types. More preferably surfactants are selected from the group consisting of anionic, nonionic, cationic surfactants and mixtures thereof. Detergent surfactants useful herein are described in U.S. Pat. No. 3,664,961, Norris, issued May 23, 1972, U.S. Pat. No. 3,919,678, Laughlin et al., issued Dec. 30, 1975, U.S. Pat. No. 4,222,905, Cockrell, to issued Sep. 16, 1980, and in U.S. Pat. No. 4,239,659, Murphy, issued Dec. 16, 1980. Anionic and nonionic surfactants are preferred.

Useful anionic surfactants can themselves be of several different types. For example, water-soluble salts of the higher fatty acids, i.e., “soaps”, are useful anionic surfactants in the compositions herein. This includes alkali metal soaps such as the sodium, potassium, ammonium, and alkyl ammonium salts of higher fatty acids containing from about 8 to about 24 carbon atoms, and preferably from about 12 to about 18 carbon atoms. Soaps can be made by direct saponification of fats and oils or by the neutralization of free fatty acids. Particularly useful are the sodium and potassium salts of the mixtures of fatty acids derived from coconut oil and tallow, i.e., sodium or potassium tallow and coconut soap.

Additional non-soap anionic surfactants which are suitable for use herein include the water-soluble salts, preferably the alkali metal, and ammonium salts, of organic sulfuric reaction products having in their molecular structure an alkyl group containing from about 10 to about 20 carbon atoms and a sulfonic acid or sulfuric acid ester group. (Included in the term “alkyl” is the alkyl portion of acyl groups). Examples of this group of synthetic surfactants include: a) the sodium, potassium and ammonium alkyl sulfates, especially those obtained by sulfating the higher alcohols (C₈-C₁₈ carbon atoms) such as those produced by reducing the glycerides of tallow or coconut oil; b) the sodium, potassium and ammonium alkyl polyethoxylate sulfates, particularly those in which the alkyl group contains from 10 to 22, preferably from 12 to 18 carbon atoms, and wherein the polyethoxylate chain contains from 1 to 15, preferably 1 to 6 ethoxylate moieties; and c) the sodium and potassium alkylbenzene sulfonates in which the alkyl group contains from about 9 to about 15 carbon atoms, in straight chain or branched chain configuration, e.g., those of the type described in U.S. Pat. Nos. 2,220,099 and 2,477,383. Especially valuable are linear straight chain alkylbenzene sulfonates in which the average number of carbon atoms in the alkyl group is from about 11 to 13, abbreviated as C₁₁-C₁₃ LAS.

In some embodiments, the total anionic surfactant, i.e., soap and non-soap anionic, is present in the composition at a weight percentage of 1 wt % to 65 wt %, 2 wt % to 50 wt %, or 5 wt % to 45 wt %.

Preferred nonionic surfactants are those of the formula R₁(OC₂H₄)ₙOH, wherein R₁ is a C₁₀-C₁₆ alkyl group or a C₈-C₁₂ alkyl phenyl group, and n is from 3 to about 80. Particularly preferred are condensation products of C₁₂-C₁₅ alcohols with from about 5 to about 20 moles of ethylene oxide per mole of alcohol, e.g., C₁₂-C₁₃ alcohol condensed with about 6.5 moles of ethylene oxide per mole of alcohol.

The Solvent System:

The cleaning composition may comprise a solvent system. The solvent system may contain water alone or mixtures of organic solvents with water. Preferred organic solvents include 1,2-propanediol, ethanol, glycerol, dipropylene glycol, methyl propane diol and mixtures thereof.

Other lower alcohols, C₁-C₄ alkanolamines such as monoethanolamine and triethanolamine, can also be used. Solvent systems can be absent, for example from anhydrous solid embodiments of the disclosure, but more typically are present at levels in the range of from about 0.1% to about 98%, preferably at least about 1% to about 50%, more usually from about 5% to about 25%.

### EXAMPLES

### Example A

### Perfume Composition

Perfume of example A comprises more than 95% of perfume raw material selected from Lavandin Grosso oil; Iso Propyl-2-Methyl Butyrate; Dimethyl cyclohexenyl 3-butenyl ketone; Eucalyptol; Benzyl Acetate; Hexyl Acetate; Methyl Benzoate; 3a,4,5,6,7,7a-hexahydro-4,7-methano-1H-indenyl acetate; Octanal; Cis-3 hexen-1-ol; Nonanal; Ethyl-2-methyl Butyrate; (Z,E)-2,4-dimethyl cyclohex-3-ene-1-carbaldehyde; Tetrahydro-4-methyl-2-(2-methyl propenyl)-2H-pyran; Geraniol; Iso propylbutanal; 2-pentylcyclopentan-1-ol; Dodecenal; d-limonene; Allyl Caproate; Decenal; Tetra Hydro Linalool; (E)-1-trimethyl-1-cyclohex-3(2,6,6-enyl)but-2-en-1-one; 2,4,6-trimethyl-3-cyclohexene-1-carboxaldehyde; Ionone Beta; Prenyl Acetate; 3-(4-tert-butylphenyl)propanal; 1 Carvone; Allyl Cyclohexyl Propionate; Linalool; Phenyl ethyl alcohol; Lemon Oil; Eugenol; Ethyl Vanillin; Cis-3-Hexenyl Acetate; Diphenyl Oxyde; Ionone Alpha; prop-2-enyl 2-cyclohexyloxyacetate; 2-pentyl-Cyclopentanone; Ethyl-2-methyl Pentanoate; [(4Z)-1-cyclooct-4-enyl]methyl carbonate; Cedryl Acetate; Cinnamic Alcohol; 2-methoxyethylbenzene; Phenyl Ethyl Phenyl Acetate; Citronellol; 2-tert-butyl cyclohexyl acetate; Citral; 3alpha,4,5,6,7,7alpha-hexahydro-4,7-methano-1H-inden-6-yl propanoate; Iso-bornyl iso-butyrate.

More than 80% by weight of Perfume of example A is constituted by a mixture of Benzyl acetate; 2-pentylcyclopentan-1-ol; eucalyptol; 3a,4,5,6,7,7a-hexahydro-4,7-methano-1H-indenyl acetate; geraniol; ionone alpha; ionone beta; (Z,E)-2,4-dimethyl cyclohex-3-ene-1-carbaldehyde; linalool; Phenyl Ethyl Alcohol; and (4Z)-1-cyclooct-4-enyl]methyl carbonate.

### DETERGENT EXAMPLES

### Examples 1-5

### Unit Dose Laundry detergent compositions of the present invention are provided below. The film used to encapsulate the cleaning composition is M8630, a PVOH copolymer film available from MONOSOL. LLC, Merrillville, Ind. (USA).

| | 1 | 2 | 3 | 4 | 5 |
|---|---|---|---|---|---|
| | (wt %) | (wt %) | (wt %) | (wt %) | (wt %) |
| Alkylbenzene sulfonic | 14.5 | 14.5 | 14.5 | 14.5 | 14.5 |
| acid | | | | | |
| C₁₂₋₁₈ alkyl ethoxy 3 | 7.5 | 7.5 | 7.5 | 7.5 | 7.5 |
| sulfate | | | | | |
| C₁₂₋₁₈ alkyl 7-ethoxylate | 13.0 | 13.0 | 13.0 | 13.0 | 13.0 |
| Citric Acid | 0.6 | 0.6 | 0.6 | 0.6 | 0.6 |
| Fatty Acid | 14.8 | 14.8 | 14.8 | 14.8 | 14.8 |
| *Amylase of this | 6.0 | 12.0 | 8.0 | 2.0 | 10.0 |
| invention (mg active) | | | | | |
| **Amylase (mg active) | 6.0 | | 4.0 | 8.0 | |
| Ethoxylated | 4.0 | 4.0 | 4.0 | 4.0 | 4.0 |
| Polyethylenimine¹ | | | | | |
| Protease (Purafect | 1.4 | 2.0 | 0.9 | 1.2 | |
| Prime ®, 40.6 mg | | | | | |
| active/g) | | | | | |
| Hydroxyethane | 1.2 | 1.2 | 1.2 | 1.2 | 1.2 |
| diphosphonic acid | | | | | |
| Brightener | 0.3 | 0.3 | 0.3 | 0.3 | 0.3 |
| P-diol | 15.8 | 13.8 | 13.8 | 13.8 | 13.8 |
| Glycerol | 6.1 | 6.1 | 6.1 | 6.1 | 6.1 |
| MEA | 8.0 | 8.0 | 8.0 | 8.0 | 8.0 |
| TIPA | | | 2.0 | | |
| TEA | | 2.0 | | | |
| Cumene sulphonate | | | | | 2.0 |
| Cyclohexyl dimethanol | | | | 2.0 | |
| Water | 10 | 10 | 10 | 10 | 10 |
| Structurant | 0.14 | 0.14 | 0.14 | 0.14 | 0.14 |
| ***Perfume | 1.9 | 1.9 | 1.9 | 1.9 | 1.9 |

| | |
|---|---|
| Buffers | To pH 8.0 |
| (monoethanolamine) | |
| Solvents (1,2 | To 100% |
| propanediol, ethanol) | |

*Amylase of the present invention is shown as mgs of active enzyme per 100 g of detergent.
**Amylase such Natalase ® is shown as active enzyme per 100 g of detergent.
***Perfume of example A.
¹Polyethylenimine (MW = 600) with 20 ethoxylate groups per —NH.

### Example 6-8

### Multiple Compartment Unit Dose Compositions

Multiple compartment unit dose laundry detergent formulations of the present invention are provided below. In these examples the unit dose has three compartments.

| Base composition 6 | (wt %) |
|---|---|
| Glycerol (min 99) | 5.3 |
| 1,2-propanediol | 10.0 |
| Citric Acid | 0.5 |
| Monoethanolamine | 10.0 |
| Caustic soda | — |
| Dequest 2010 | 1.1 |
| Potassium sulfite | 0.2 |
| *Amylase of this invention (mg active) | 10.0 |
| Nonionic Marlipal C24EO7 | 20.1 |
| HLAS | 24.6 |
| Optical brightener FWA49 | 0.2 |
| C12-15 Fatty acid | 16.4 |
| Polymer Lutensit Z96 | 2.9 |
| Polyethyleneimine ethoxylate PEI600 E20 | 1.1 |
| MgCl2 | 0.2 |
| Solvents (1,2 propanediol, ethanol) | To 100% |

| | Composition | | | | | |
|---|---|---|---|---|---|---|
| | 6A | | | 6B | | |
| Compartment | A | B | C | A | B | C |
| Volume of | 40 ml | 5 ml | 5 ml | 40 ml | 5 ml | 5 ml |
| each compart- | | | | | | |
| ment | | | | | | |
| Active material | | | | | | |
| in Wt. % | | | | | | |
| ***Perfume | 1.6 | 1.6 | 2.0 | 1.6 | 1.6 | 1.2 |
| Dyes | <0.01 | <0.01 | <0.01 | <0.01 | <0.01 | <0.01 |
| TiO2 | 0.1 | | | | 0.1 | |
| Sodium Sulfite | 0.4 | 0.4 | 0.4 | 0.3 | 0.3 | 0.3 |
| Acusol 305 | 1.2 | | | 2 | | |
| Hydrogenated | 0.14 | 0.14 | 0.14 | 0.14 | 0.14 | 0.14 |
| castor oil | | | | | | |
| Base | Add to | Add to | Add to | Add to | Add to | Add to |
| Composition 6 | 100% | 100% | 100% | 100% | 100% | 100% |

*Amylase of the present invention is shown as mgs of active enzyme per 100 g of detergent.
***Perfume of example A.

| Base composition 7 | (wt %) |
|---|---|
| Glycerol (min 99) | 5.3 |
| 1,2-propanediol | 10.0 |
| Citric Acid | 0.5 |
| Monoethanolamine | 10.0 |
| Dequest 2010 | 1.1 |
| Potassium sulfite | 0.2 |
| *Amylase of this invention (mg active) | 9.0 |
| **Amylase (mg active) | 5.0 |
| Protease (Purafect Prime ®, 40.6 mg | 2.0 |
| active/g) | |
| Nonionic Marlipal C24EO7 | 20.1 |
| HLAS | 24.6 |
| Optical brightener FWA49 | 0.2 |
| C12-15 Fatty acid | 16.4 |
| Polymer Lutensit Z96 | 2.9 |
| Polyethyleneimine ethoxylate PEI600 E20 | 1.1 |
| MgCl₂ | 0.2 |
| Solvents (1,2 propanediol, ethanol) | To 100% |

| | Composition | | | | | |
|---|---|---|---|---|---|---|
| | 7A | | | 7B | | |
| Compartment | A | B | C | A | B | C |
| Volume of | 40 ml | 5 ml | 5 ml | 40 ml | 5 ml | 5 ml |
| each compart- | | | | | | |
| ment | | | | | | |
| Active material | | | | | | |
| in Wt. % | | | | | | |
| ***Perfume | 1.6 | 2.0 | 1.5 | 1.6 | 1.6 | 1.8 |
| Dyes | <0.01 | <0.01 | <0.01 | <0.01 | <0.01 | <0.01 |
| TiO2 | 0.1 | — | — | — | 0.1 | — |
| Sodium Sulfite | 0.4 | 0.4 | 0.4 | 0.3 | 0.3 | 0.3 |
| Acusol 305 | 1.2 | | | 2 | — | — |
| Hydrogenated | 0.14 | 0.14 | 0.14 | 0.14 | 0.14 | 0.14 |
| castor oil | | | | | | |
| Base | Add to | Add to | Add to | Add to | Add to | Add to |
| Composition 7 | 100% | 100% | 100% | 100% | 100% | 100% |

*Amylase of the present invention is shown as mgs of active enzyme per 100 g of detergent.
**Amylase such as those disclosed in WO2013/003659 is shown as active enzyme per 100 g of detergent.
***Perfume of example A.

| Base composition 8 | (wt %) |
|---|---|
| Glycerol (min 99) | 5.3 |
| 1,2-propanediol | 10.0 |
| Citric Acid | 0.5 |
| Monoethanolamine | 10.0 |
| Caustic soda | — |
| Dequest 2010 | 1.1 |
| Potassium sulfite | 0.2 |
| *Amylase of this invention (mg active) | 3.0 |
| **Amylase (mg active) | 3.0 |
| Nonionic Marlipal C24EO7 | 20.1 |
| HLAS | 24.6 |
| Optical brightener FWA49 | 0.2 |
| C12-15 Fatty acid | 16.4 |
| Polymer Lutensit Z96 | 2.9 |
| Polyethyleneimine ethoxylate PEI600 E20 | 1.1 |
| MgCl2 | 0.2 |
| Solvents (1,2 propanediol, ethanol) | To 100% |

| | Composition | | | | | |
|---|---|---|---|---|---|---|
| | 8A | | | 8B | | |
| Compartment | A | B | C | A | B | C |
| Volume of | 40 ml | 5 ml | 5 ml | 40 ml | 5 ml | 5 ml |
| each compart- | | | | | | |
| ment | | | | | | |
| Active material | | | | | | |
| in Wt. % | | | | | | |
| ***Perfume | 1.6 | 1.6 | 1.6 | 1.6 | 1.6 | 1.6 |
| Protease | | 0.5 | | | | 2.0 |
| (Purafect | | | | | | |
| Prime ®, 40.6 | | | | | | |
| mg active/g) | | | | | | |
| Dyes | <0.01 | <0.01 | <0.01 | <0.01 | <0.01 | <0.01 |
| *Amylase of | | | 3.0 | | 3.0 | |
| this invention | | | | | | |
| (mg active) | | | | | | |
| TiO2 | 0.1 | — | — | — | 0.1 | — |
| Sodium Sulfite | 0.4 | 0.4 | 0.4 | 0.3 | 0.3 | 0.3 |
| Acusol 305 | 1.2 | | | 2 | — | — |
| Hydrogenated | 0.14 | 0.14 | 0.14 | 0.14 | 0.14 | 0.14 |
| castor oil | | | | | | |
| Base | Add to | Add to | Add to | Add to | Add to | Add to |
| Composition 8 | 100% | 100% | 100% | 100% | 100% | 100% |

*Amylase of the present invention is shown as mgs of active enzyme per 100 g of detergent.
**Amylase such as Natalase ® is shown as active enzyme per 100 g of detergent.
***Perfume of example A.

### Examples 9-14

Granular laundry detergent compositions designed for hand washing or top-loading washing machines.

| | 9 | 10 | 11 | 12 | 13 | 14 |
|---|---|---|---|---|---|---|
| | (wt %) | (wt %) | (wt %) | (wt %) | (wt %) | (wt %) |
| Linear alkylbenzenesulfonate | 20 | 22 | 20 | 15 | 20 | 20 |
| C₁₂₋₁₄ Dimethylhydroxyethyl | 0.7 | 0.2 | 1 | 0.6 | | |
| ammonium chloride | | | | | | |
| AE₃S | 0.9 | 1 | 0.9 | | 0.5 | 0.9 |
| AE₇ | | | | 1 | | 3 |
| Sodium tripolyphosphate | 5 | | 4 | 9 | 2 | |
| Zeolite A | | 1 | | 1 | 4 | 1 |
| 1.6R Silicate (SiO₂:Na₂O at | 7 | 5 | 2 | 3 | 3 | 5 |
| ratio 1.6:1) | | | | | | |
| Sodium carbonate | 25 | 20 | 25 | 17 | 18 | 19 |
| Polyacrylate MW 4500 | 1 | 0.6 | 1 | 1 | 1.5 | 1 |
| Random graft copolymer¹ | 0.1 | 0.2 | | | | |
| Carboxymethyl cellulose | 1 | 0.3 | 1 | 1 | 1 | 1 |
| Protease (Savinase ®, 32.89 mg | | 0.1 | 0.1 | 0.1 | | 0.1 |
| active/g) | | | | | | |
| Lipase - Lipex ® (18 mg active/g) | | 0.07 | 0.3 | 0.1 | 0.07 | 0.4 |
| *Amylase of the present | 0.63 | 1.0 | 2.0 | 0.44 | 0.88 | 0.3 |
| invention (mg active) | | | | | | |
| **Amylase (mg active) | | 1.0 | 0.5 | 0.7 | 0.15 | 0.3 |
| Fluorescent Brightener 1 | 0.06 | | 0.06 | 0.18 | 0.06 | 0.06 |
| Fluorescent Brightener 2 | 0.1 | 0.06 | 0.1 | | 0.1 | 0.1 |
| DTPA | 0.6 | 0.8 | 0.6 | 0.25 | 0.6 | 0.6 |
| MgSO₄ | 1 | 1 | 1 | 0.5 | 1 | 1 |
| Sodium Percarbonate | | 5.2 | 0.1 | | | |
| Sodium Perborate | 4.4 | | 3.85 | 2.09 | 0.78 | 3.63 |
| Monohydrate | | | | | | |
| NOBS | 1.9 | | 1.66 | | 0.33 | 0.75 |
| TAED | 0.58 | 1.2 | 0.51 | | 0.015 | 0.28 |
| Sulphonated zinc | 0.0030 | | 0.0012 | 0.0030 | 0.0021 | |
| phthalocyanine | | | | | | |
| S-ACMC | 0.1 | | | | 0.06 | |
| Direct Violet 9 | | | 0.0003 | 0.0005 | 0.0003 | |
| Acid Blue 29 | | | | | | 0.0003 |
| ***Perfume | 1.5 | 1.6 | 0.5 | 2.0 | 0.4 | 3.0 |

| | |
|---|---|
| Sulfate/Moisture | Balance |

*Amylase of the present invention is shown as mgs of active enzyme per 100 g of detergent.
**Amylase such as Stainzyme ® Plus is shown as active enzyme per 100 g of detergent.
***Perfume of example A.

### Examples 15-20

Granular laundry detergent compositions designed for front-loading automatic washing machines.

| | 15 | 16 | 17 | 18 | 19 | 20 |
|---|---|---|---|---|---|---|
| | (wt %) | (wt %) | (wt %) | (wt %) | (wt %) | (wt %) |
| Linear alkylbenzenesulfonate | 8 | 7.1 | 7 | 6.5 | 7.5 | 7.5 |
| AE₃S | | 4.8 | | 5.2 | 4 | 4 |
| C₁₂₋₁₄ Alkylsulfate | 1 | | 1 | | | |
| AE₇ | 2.2 | | 3.2 | | | |
| C₁₀₋₁₂ Dimethyl | 0.75 | 0.94 | 0.98 | 0.98 | | |
| hydroxyethylammonium chloride | | | | | | |
| Crystalline layered silicate | 4.1 | | 4.8 | | | |
| (δ-Na₂Si₂O₅) | | | | | | |
| Zeolite A | 5 | | 5 | | 2 | 2 |
| Citric Acid | 3 | 5 | 3 | 4 | 2.5 | 3 |
| Sodium Carbonate | 15 | 20 | 14 | 20 | 23 | 23 |
| Silicate 2R (SiO₂:Na₂O at | 0.08 | | 0.11 | | | |
| ratio 2:1) | | | | | | |
| Soil release agent | 0.75 | 0.72 | 0.71 | 0.72 | | |
| Acrylic Acid/Maleic Acid | 1.1 | 3.7 | 1.0 | 3.7 | 2.6 | 3.8 |
| Copolymer | | | | | | |
| Carboxymethylcellulose | 0.15 | 1.4 | 0.2 | 1.4 | 1 | 0.5 |
| Protease - Purafect ® (84 mg | 0.2 | 0.2 | 0.3 | 0.15 | 0.12 | 0.13 |
| active/g) | | | | | | |
| Lipase - Lipex ® (18.00 mg | | 0.15 | 0.1 | | | |
| active/g) | | | | | | |
| Cellulase - Celluclean ™ (15.6 mg | | | | | 0.1 | 0.1 |
| active/g) | | | | | | |
| *Amylase of the present invention | 4.0 | 2.0 | 1.0 | 0.7 | 6.0 | 3.0 |
| (mg active) | | | | | | |
| **Amylase (mg active) | | 2.0 | | 3.0 | | 0.5 |
| TAED | 3.6 | 4.0 | 3.6 | 4.0 | 2.2 | 1.4 |
| Percarbonate | 13 | 13.2 | 13 | 13.2 | 16 | 14 |
| Na salt of Ethylenediamine-N,N′- | 0.2 | 0.2 | 0.2 | 0.2 | 0.2 | 0.2 |
| disuccinic acid, (S,S) isomer | | | | | | |
| (EDDS) | | | | | | |
| Hydroxyethane di phosphonate | 0.2 | 0.2 | 0.2 | 0.2 | 0.2 | 0.2 |
| (HEDP) | | | | | | |
| MgSO₄ | 0.42 | 0.42 | 0.42 | 0.42 | 0.4 | 0.4 |
| ***Perfume | 0.5 | 0.6 | 0.5 | 0.6 | 0.6 | 0.6 |
| Suds suppressor agglomerate | 0.05 | 0.1 | 0.05 | 0.1 | 0.06 | 0.05 |
| Soap | 0.45 | 0.45 | 0.45 | 0.45 | | |
| Sulphonated zinc phthalocyanine | 0.0007 | 0.0012 | 0.0007 | | | |
| (active) | | | | | | |
| S-ACMC | 0.01 | 0.01 | | 0.01 | | |
| Direct Violet 9 (active) | | | 0.0001 | 0.0001 | | |

| | |
|---|---|
| Sulfate/Water & Miscellaneous | Balance |

*Amylase of the present invention is shown as mgs of active enzyme per 100 g of detergent.
**Amylase such as Stainzyme ® Plus is shown as active enzyme per 100 g of detergent.
***Perfume of example A.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to the term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A cleaning composition, comprising:
an alpha-amylase with at least about 90% identity with an alpha-amylase selected from the alpha-amylase of SEQ ID NO:1 and the alpha-amylase of SEQ ID NO:2;
a perfume comprising a mixture of at least 5 perfume raw materials and wherein the perfume comprises at least about 20 wt % of perfume raw material selected from: Lavandin Grosso oil; Iso Propyl-2-Methyl Butyrate; Dimethyl cyclohexenyl 3-butenyl ketone; Eucalyptol; Benzyl Acetate; Hexyl Acetate; Methyl Benzoate; 3a,4,5,6,7,7a-hexahydro-4,7-methano-1H-indenyl acetate; Octanal; Cis-3 hexen-1-ol; Nonanal; Ethyl-2-methyl Butyrate; (Z,E)-2,4-dimethyl cyclohex-3-ene-1-carbaldehyde, Tetrahydro-4-methyl-2-(2-methyl propenyl)-2H-pyran; Geraniol; Iso propylbutanal; 2-pentylcyclopentan-1-ol; Dodecenal; d-limonene; Allyl Caproate; Decenal; Tetra Hydro Linalool; (E)-1-trimethyl-1-cyclohex-3 (2,6,6-enyl)but-2-en-1-one; 2,4,6-trimethyl-3-cyclohexene-1-carboxaldehyde; Ionone Beta; Prenyl Acetate; 3-(4-tert-butylphenyl)propanal; 1 Carvone; Allyl Cyclohexyl Propionate; Linalool; Phenyl ethyl alcohol; Lemon Oil; Eugenol; Ethyl Vanillin; Cis-3-Hexenyl Acetate; Diphenyl Oxyde; Ionone Alpha; prop-2-enyl 2-cyclohexyloxyacetate; 2-pentyl-Cyclopentanone; Ethyl-2-methyl Pentanoate; [(4Z)-1-cyclooct-4-enyl]methyl carbonate; Cedryl Acetate; Cinnamic Alcohol; 2-methoxyethylbenzene; Phenyl Ethyl Phenyl Acetate; Citronellol; 2-tert-butyl cyclohexyl acetate; Citral; 3alpha,4,5,6,7,7alpha-hexahydro-4,7-methano-1H-inden-6-yl propanoate; Iso-bornyl iso-butyrate; and mixture thereof.

2. The cleaning composition according to claim 1, wherein the alpha-amylase has at least about 98% identity with an alpha-amylase selected from the alpha-amylase of SEQ ID NO:1 and the alpha-amylase of SEQ ID NO:2.

3. The cleaning composition according to claim 1, wherein the perfume comprises a mixture of at least 5 perfume raw materials and wherein the perfume comprises at least about 40 wt % of perfume raw material selected from: Lavandin Grosso oil; Iso Propyl-2-Methyl Butyrate; Dimethyl cyclohexenyl 3-butenyl ketone; Eucalyptol; Benzyl Acetate; Hexyl Acetate; Methyl Benzoate; 3a,4,5,6,7,7a-hexahydro-4,7-methano-1H-indenyl acetate; Octanal; Cis-3 hexen-1-ol; Nonanal; Ethyl-2-methyl Butyrate; (Z,E)-2,4-dimethyl cyclohex-3-ene-1-carbaldehyde, Tetrahydro-4-methyl-2-(2-methyl propenyl)-2H-pyran; Geraniol; Iso propylbutanal; 2-pentylcyclopentan-1-ol; Dodecenal; d-limonene; Allyl Caproate; Decenal; Tetra Hydro Linalool; (E)-1-trimethyl-1-cyclohex-3(2,6,6-enyl)but-2-en-1-one; 2,4,6-trimethyl-3-cyclohexene-1-carboxaldehyde; Ionone Beta; Prenyl Acetate; 3-(4-tert-butylphenyl)propanal; 1 Carvone; Allyl Cyclohexyl Propionate; Linalool; Phenyl ethyl alcohol; Lemon Oil; Eugenol; Ethyl Vanillin; Cis-3-Hexenyl Acetate; Diphenyl Oxyde; Ionone Alpha; prop-2-enyl 2-cyclohexyloxyacetate; 2-pentyl-Cyclopentanone; Ethyl-2-methyl Pentanoate; [(4Z)-1-cyclooct-4-enyl]methyl carbonate; Cedryl Acetate; Cinnamic Alcohol; 2-methoxyethylbenzene; Phenyl Ethyl Phenyl Acetate; Citronellol; 2-tert-butyl cyclohexyl acetate; Citral; 3alpha,4,5,6,7,7alpha-hexahydro-4,7-methano-1H-inden-6-yl propanoate; Iso-bornyl iso-butyrate; and mixture thereof.

4. The cleaning composition according to claim 3, wherein the perfume comprises a mixture of at least 7 perfume raw materials and wherein the perfume comprises at least about 60 wt % of perfume raw material selected from: Lavandin Grosso oil; Iso Propyl-2-Methyl Butyrate; Dimethyl cyclohexenyl 3-butenyl ketone; Eucalyptol; Benzyl Acetate; Hexyl Acetate; Methyl Benzoate; 3a,4,5,6,7,7a-hexahydro-4,7-methano-1H-indenyl acetate; Octanal; Cis-3 hexen-1-ol; Nonanal; Ethyl-2-methyl Butyrate; (Z,E)-2,4-dimethyl cyclohex-3-ene-1-carbaldehyde, Tetrahydro-4-methyl-2-(2-methyl propenyl)-2H-pyran; Geraniol; Iso propylbutanal; 2-pentylcyclopentan-1-ol; Dodecenal; d-limonene; Allyl Caproate; Decenal; Tetra Hydro Linalool; (E)-1-trimethyl-1-cyclohex-3(2,6,6-enyl)but-2-en-1-one; 2,4,6-trimethyl-3-cyclohexene-1-carboxaldehyde; Ionone Beta; Prenyl Acetate; 3-(4-tert-butylphenyl)propanal; 1 Carvone; Allyl Cyclohexyl Propionate; Linalool; Phenyl ethyl alcohol; Lemon Oil; Eugenol; Ethyl Vanillin; Cis-3-Hexenyl Acetate; Diphenyl Oxyde; Ionone Alpha; prop-2-enyl 2-cyclohexyloxyacetate; 2-pentyl-Cyclopentanone; Ethyl-2-methyl Pentanoate; [(4Z)-1-cyclooct-4-enyl]methyl carbonate; Cedryl Acetate; Cinnamic Alcohol; 2-methoxyethylbenzene; Phenyl Ethyl Phenyl Acetate; Citronellol; 2-tert-butyl cyclohexyl acetate; Citral; 3alpha,4,5,6,7,7alpha-hexahydro-4,7-methano-1H-inden-6-yl propanoate; Iso-bornyl iso-butyrate; and mixture thereof.

5. A pouch comprising a cleaning composition according to claim 1.

6. The pouch according to claim 1, wherein the pouch comprises a water-soluble film comprising at least about 50% by weight of a water-soluble polyvinyl alcohol (PVOH) resin, the resin having an average viscosity in a range of about 10 cP to about 30 cP and a degree of hydrolysis in a range of about 84% to about 98%.
